(19) United States
(12) Patent Application Publication
(10) Pub. No.: US 2016/0373294 A1
(43) Pub. Date: Dec. 22, 2016

(54) FLOW MANAGEMENT IN A LINK AGGREGATION GROUP SYSTEM

(71) Applicant: Fortinet, Inc., Sunnyvale, CA (US)

(72) Inventors: Amit Srivastav, Cupertino, CA (US); Sandip Y. Borle, Cupertino, CA (US); Joseph R. Mihelich, Folsom, CA (US)

(73) Assignee: Fortinet, Inc., Sunnyvale, CA (US)

(21) Appl. No.: 14/742,939

(22) Filed: Jun. 18, 2015

(51) Int. Cl. H04L 12/24; H04L 29/08

(52) U.S. Cl. CPC H04L 41/0668; H04L 41/12; H04L 67/125

(57) ABSTRACT

Systems and methods for an end-to-end bidirectional symmetric data flow mapping in a LAG system are provided. According to one embodiment, a forward flow from a first end of the LAG system is received by a second end. The forward flow is from a first device connected to the first end and directed to a second device connected to the second end. The forward flow is transmitted by the second end to the second device. A corresponding backward flow is received by the second end that is from the second device and directed to the first device. The backward flow is assigned by the second end to a member link of multiple member links connecting the first and second end on which the forward flow was received by the second end. The backward flow is transmitted by the second end to the first end through the assigned member link.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright © 2015, Fortinet, Inc.

### BACKGROUND

Field

Embodiments of the present invention generally relate to the field of computer networking techniques. In particular, various embodiments relate to management of flows in link aggregation group (LAG) systems.

Description of the Related Art

In an end-to-end link aggregation group (LAG) or link-bundle system, multiple network cables between a first end and a second end of the LAG system are aggregated to create a single, virtual, communication link that is faster than a single link. Each of the multiple network cables is a member link of the LAG system. When a bidirectional data flow is transmitted between the pair of ends of the LAG system, a member link among all the member links of the LAG system is selected for transmitting the bidirectional data flow independently by the first end and the second end based on some algorithms. For example, when a forward data flow that is to be transmitted from a first network device to a second network device is received by the first end of the LAG system, the first end may independently select a member link based on a hash algorithm and some parameters of the forward data flow in order that all data packets of the forward data flow will go through the same member link while multiple data flows may be load-balanced among member links. The forward data flow is then transmitted to the second end through the selected member link and routed to the second network device by the second end. When a backward data flow that is to be transmitted from the second network device to the first network device is received by the second end, the second end may independently select a member link among all the member links based on a hash algorithm and some parameters of the backward data flow and transmits the backward data flow through the selected member link to the first end. In this example, the member links selected by the first end and the second end for transmitting the same bidirectional data flow may be different even though the same hash algorithm may be used on both ends because the order of member ports on each end may be not the same.

FIG. 1 shows an example of a prior art asymmetric end-to-end member link selection in a LAG system 100. In the example shown in FIG. 1, Port-1, 3, 7 and 8 are member ports of End-A of LAG system 100 and Port-1, 2, 4 and 7 are member ports of End-B of LAG system 100. Member links connecting member ports of both ends are as follows:

Member link 1: Port-1/End-A->Port-2/End-B

Member link 2: Port-3/End-A->Port-4/End-B

Member link 3: Port-7/End-A->Port-7/End-B

Member link 4: Port-8/End-A->Port-1/End-B

Bidirectional data flows are assigned to member links independently by both ends as follows:

Forward data flow 1, 2 are assigned by End A to its 1st member port (member link 1)

Forward data flow 3, 4 are assigned by End A to its 2nd member port (member link 2)

Forward data flow 5, 6 are assigned by End A to its 3rd member port (member link 3)

Forward data flow 7, 8 are assigned by End A to its 4th member port (member link 4)

Backward data flow 1, 2 are assigned by End-B to its 1st member port (member link 4)

Backward data flow 3, 4 are assigned by End B to its 2nd member port (member link 1)

Backward data flow 5, 6 are assigned by End B to its 3rd member port (member link 2)

Backward data flow 7, 8 are assigned by End B to its 4th member port (member link 3)

Because physical link connections between End-A and End-B are asymmetric, member port mapping at the two ends is asymmetric and results in a bidirectional data flow between the two ends that may be transmitted through different member links in forward and backward directions. If port-1 of End-A goes down, member link 1 is broken. Data flow 1-4 that are assigned to member link 1 would need rehashing on End-A and End-B. Hence all the data flows would actually be disrupted throughout the duration of link failure detection and rehashing of flows by both ends.

Therefore, there is a need for improved data flow mappings in a LAG system in order to reduce the number of data flows that are impacted and that need to be rehashed as a result of a link failure.

### SUMMARY

Systems and methods are described for an end-to-end bidirectional symmetric data flow mapping in a LAG system. According to one embodiment, a method is provided for selecting member links connecting a first end of a LAG system to a second end of the LAG system to carry data flows. A forward data flow of a bidirectional data flow from the first end is received by the second end. The forward data flow is from a first network device that is connected to the first end and directed to a second network device that is connected to the second end. The forward data flow is transmitted by the second end to the second network device. A backward data flow of the bidirectional data flow is received by the second end that is from the second network device and directed to the first network device. The backward data flow is assigned by the second end to a member link on which the forward data flow was received by the second end. The backward data flow is transmitted by the second end to the first end through the assigned member link.

Other features of embodiments of the present invention will be apparent from the accompanying drawings and from the detailed description that follows.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 conceptually illustrates the flow assignment of a typical prior art LAG system;

FIG. 2 conceptually illustrates the flow assignment of a LAG system in accordance with an embodiment of the present invention;

FIG. 3 illustrates exemplary functional units of a network switch supporting LAG in accordance with an embodiment of the present invention.

FIGS. 4A-4C are flow diagrams illustrating a method for negotiating between two ends of a LAG system to determine an algorithm for assigning member links in accordance with an embodiment of the present invention.

FIG. 5 is a flow diagram illustrating a method for transmitting a bidirectional data flow on a LAG system in accordance with an embodiment of the present invention.

FIG. 6 is an exemplary computer system in which or with which embodiments of the present invention may be utilized.

### DETAILED DESCRIPTION

Systems and methods are described for an end-to-end bidirectional symmetric data flow mapping in a LAG system. In one embodiment, the LAG system comprises a first end and a second end, the first end and the second end comprise multiple member ports, each member port on the first end is connected to each member port on the second end by cables to establish multiple member links of the LAG system. The first end receives a forward data flow and transmits it to the second end. When the second end receives a backward data flow, a member link on which the forward data flow is received by the second end is assigned. The second end transmits the backward data flow to the first end on the assigned port.

In the following description, numerous specific details are set forth in order to provide a thorough understanding of embodiments of the present invention. It will be apparent, however, to one skilled in the art that embodiments of the present invention may be practiced without some of these specific details. In other instances, well-known structures and devices are shown in block diagram form.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, the steps may be performed by a combination of hardware, software, firmware and/or by human operators.

Embodiments of the present invention may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware). Moreover, embodiments of the present invention may also be downloaded as one or more computer program products, wherein the program may be transferred from a remote computer to a requesting computer by way of data signals embodied in a carrier wave or other propagation medium via a communication link (e.g., a modem or network connection).

In various embodiments, the article(s) of manufacture (e.g., the computer program products) containing the computer programming code may be used by executing the code directly from the machine-readable storage medium or by copying the code from the machine-readable storage medium into another machine-readable storage medium (e.g., a hard disk, RAM, etc.) or by transmitting the code on a network for remote execution. Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

Notably, while embodiments of the present invention may be described using modular programming terminology, the code implementing various embodiments of the present invention is not so limited. For example, the code may reflect other programming paradigms and/or styles, including, but not limited to object-oriented programming (OOP), agent oriented programming, aspect-oriented programming, attribute-oriented programming (@OP), automatic programming, dataflow programming, declarative programming, functional programming, event-driven programming, feature oriented programming, imperative programming, semantic-oriented programming, functional programming, genetic programming, logic programming, pattern matching programming and the like.

### TERMINOLOGY

Brief definitions of terms used throughout this application are given below.

The phrase “network appliance” generally refers to a specialized or dedicated device for use on a network in virtual or physical form. Some network appliances are implemented as general-purpose computers with appropriate software configured for the particular functions to be provided by the network appliance; others include custom hardware (e.g., one or more custom Application Specific Integrated Circuits (ASICs)). Examples of functionality that may be provided by a network appliance include, but is not limited to, Layer 2/3 routing, content inspection, content filtering, firewall, traffic shaping, application control, Voice over Internet Protocol (VoIP) support, Virtual Private Networking (VPN), IP security (IPSec), Secure Sockets Layer (SSL), antivirus, intrusion detection, intrusion prevention, Web content filtering, spyware prevention and anti-spam. Examples of network appliances include, but are not limited to, network gateways and network security appliances (e.g., FORTIGATE family of network security appliances and FORTICARRIER family of consolidated security appliances), messaging security appliances (e.g., FORTIMAIL family of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTIWIFI family of wireless security gateways), FORIDDOS, wireless access point appliances (e.g., FORTIAP wireless access points), switches (e.g., FORTISWITCH family of switches) and IP-PBX phone system appliances (e.g., FORTIVOICE family of IP-PBX phone systems).

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

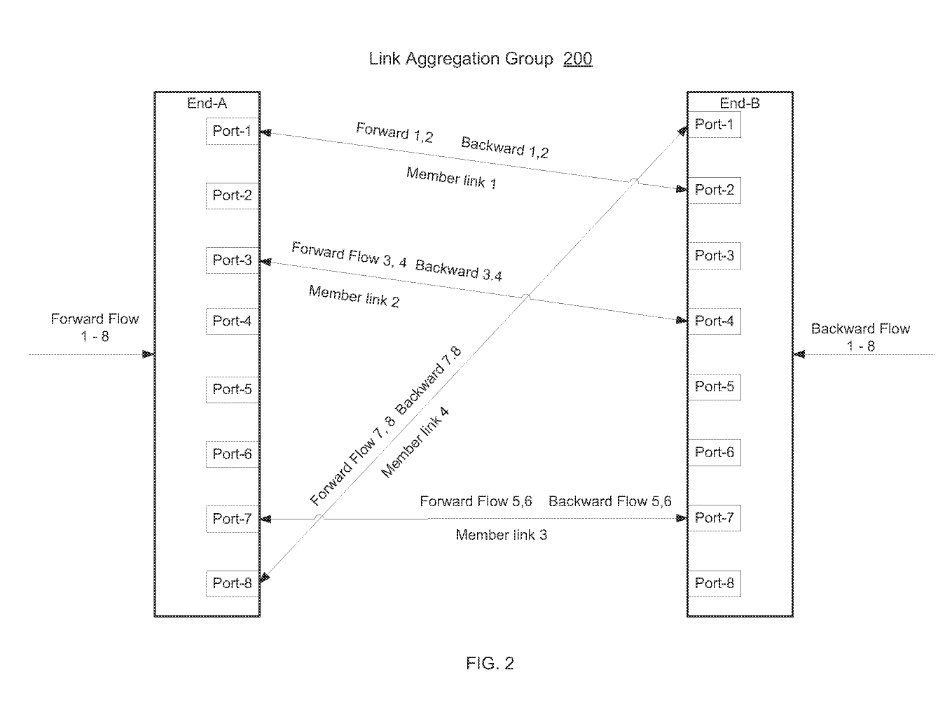

FIG. 2 conceptually illustrates data flow assignment of a LAG system 200 in accordance with an embodiment of the present invention. In the present example, member ports on both ends of LAG system 200 are asymmetric. However, the dynamic mappings of member port pairs of member links are maintained on both ends based on the current member link connections. The order of member ports may be sorted in the same order on both ends. A mapping of member ports of both ends is shown in Table 1.

TABLE 1

| | End-A (Master End) | End-B (Slave End Member) |
|---|---|---|
| Priority | Member Port list | Port list |
| #1 | Port-1 | Port-2 (port-2→ port-1 of End-A) |
| #1 | Port-7 | Port-7 (port-7→ port-7 of End-A) |
| #2 | Port-3 | Port-4 (port-4→ port-3 of End-A) |
| #2 | Port-8 | Port-1 (port-1→ port-8 of End-A) |

When a data flow is to be transmitted to a remote end, the local end may select a member port from the mapping table in order that a forward data flow and a backward data flow of the same bidirectional data flow are assigned to the same member link by both ends independently. Bidirectional data flows are assigned to member links by both ends as follows:

Forward data flow 1, 2 are assigned by End A to its 1st member port in (member link 1)

Forward data flow 3, 4 are assigned by End A to its 2nd member port (member link 2)

Forward data flow 5, 6 are assigned by End A to its 3rd member port (member link 3)

Forward data flow 7, 8 are assigned by End A to its 4th member port (member link 4)

Backward data flow 1, 2 are assigned by End-B to its 1st member port (member link 4)

Backward data flow 3, 4 are assigned by End B to its 2nd member port (member link 1)

Backward data flow 5, 6 are assigned by End B to its 3rd member port (member link 2)

Backward data flow 7, 8 are assigned by End B to its 4th member port (member link 3)

In the present example, backward data flows of bidirectional data flows are assigned to the port to which the corresponding forward data flow is received by an end of the LAG system 200. Therefore, a forward data flow and its corresponding backward data flow are transmitted on the same member link between the two ends of the LAG system 200. When multiple bidirectional data flows are transmitted between the ends of LAG system 200, these bidirectional data flows are load-balanced among member links of LAG system 200. Each of the member links carries a portion of the bidirectional data flows. When a failure occurs on a member link for any reason, fewer bidirectional data flows are affected as compared to LAG systems of prior art because both forward data flows and backward data flows of the bidirectional data flows are carried on the failed member link in accordance with embodiments of the present invention. As such, only the bidirectional data flows that were assigned to the failed member link need to be reassigned to other member links.

In the present example, member ports on End-A and End-B are asymmetric. That is, a different set of ports are used on End-A than are used on End-B and/or are ordered differently. Also, the member ports that are to be used for transmitting a bidirectional data flow are selected by End-A and End-B independently. That is, End-A performs a link selection hash algorithm for forward flows and End-B performs a link selection hash algorithm for corresponding backward flows. Despite this, in accordance with embodiments of the present invention, the member ports selected by both ends will be the ports that are part of the same member link.

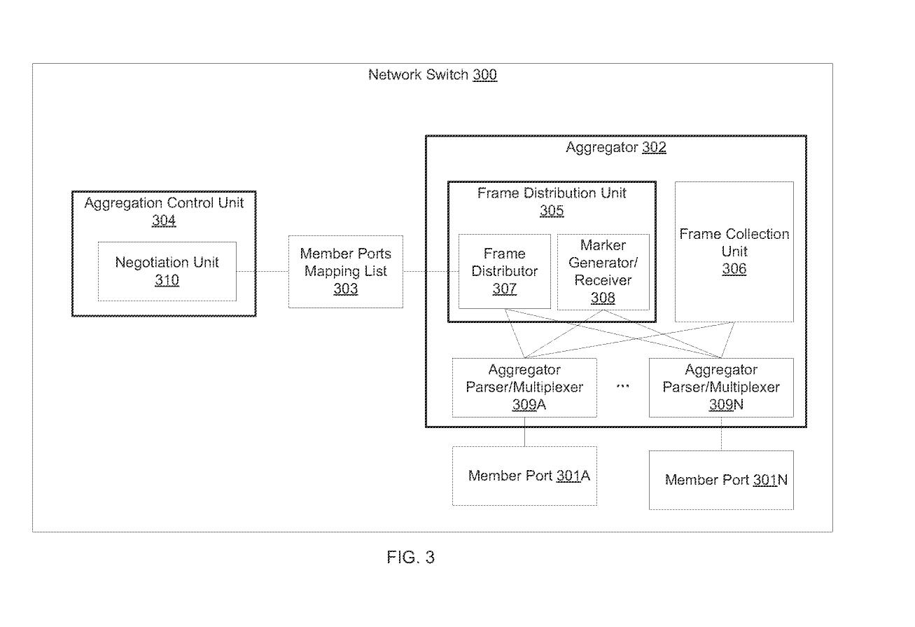

According to one embodiment, a local end of LAG system 200 can maintain a member port list that is sorted so as to correspond to the sorted member port list of the remote end. When a bidirectional data flow is transmitted, both ends of LAG system 200 may select a member port from the sorted member port list based on the same algorithm. Therefore, the selected member ports by both ends will be the ports of the same member link. This will be described in further detail below with reference to FIGS. 3, 4A-4C and 5.

FIG. 3 illustrates exemplary functional units of LAG system of a network switch 300 in accordance with an embodiment of the present invention. In the present example, network switch 300, which can be used as an end of a LAG system such as LAG system 200, comprises multiple member ports 301, aggregator 302, member port mapping list 303 and aggregation control unit 304.

Member ports 301A-N comprise multiple physical ports of network switch 300 that can be connected to member ports of another network switch to form member links of a link aggregation group. Member ports 301A-N may be part or all of physical ports of network switch 300. In accordance with embodiments of the present invention, member ports of one end of a LAG system can be connected to member ports of its peer end in any order.

The multiple member links are aggregated by aggregator 302 to create a single, virtual, communication link that is faster than a single member link. Aggregator 302 may comprise frame distribution unit 305, frame collection unit 306 and multiple aggregator parser/multiplexer units 309A-N. Frame collection unit 306 comprises frame distributor 307 and marker generator/receiver 308. Frame distributor 307 is used for taking frames of a bidirectional data flow submitted by a media access control (MAC) client (not shown) and submitting them for transmission on an appropriate port of member ports 301A-N, based on a frame distribution algorithm employed by frame distributor 307. Marker generator/receiver 308 is an optional unit that is used for marker protocol that allows the distribution function of an actor's link aggregation sublayer to request the transmission of a marker protocol data unit (PDU) on a given link. Frame collection unit 306 is used for receiving incoming frames of a bidirectional data flow from member port 301A-N and delivering them to the MAC client. Frames received from member port 301A-N are delivered to the MAC client in the order that they are received by frame collection unit 306. Aggregator parser/multiplexer units 309A-N are used for passing frame transmission requests from frame distributor 307, marker generator/receiver 308 and/or marker responder (not shown) to an appropriate member ports 301A-N. When a frame is received by a member port 301A-N, aggregator parser/multiplexer unit 309A-N passes it each to the appropriate entity, such as marker responder, marker receiver, and frame collector.

In the present example, frame distributor 307 may assign a backward data flow to a member port from member port mapping list 303 to ensure that the member port assigned is the one on which a corresponding forward data flow of the same bidirectional data flow is received by network switch 300. An example of member port mapping list 303 is illustrated above in Table 1. The member port mapping list 303 may be configured by the administrator of the LAG system according to the physical ports' connections between ends of LAG system. When the port connection between ends of the LAG system is changed, the member port mapping list 303 may be updated by the administrator accordingly.

In the present example, member port mapping list 303 may be configured and managed automatically by aggregation control unit 304 that is used for the configuration and control of the link aggregation system. Aggregation control unit 304 may incorporate a Link Aggregation Control Protocol (LACP) that can be used for automatic communication of aggregation capabilities between members and automatic configuration of link aggregation. In one example, aggregation control unit 304 may include negotiation unit 310 that is used for transmitting a local member port list of network switch 300 to a peer end of the LAG system periodically or on-the-fly.

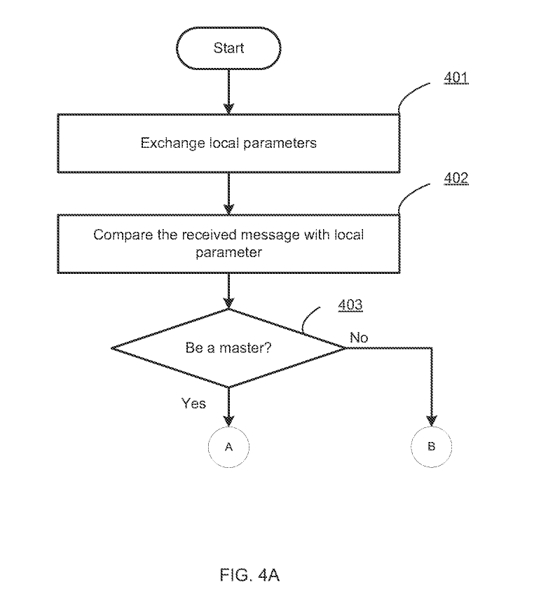

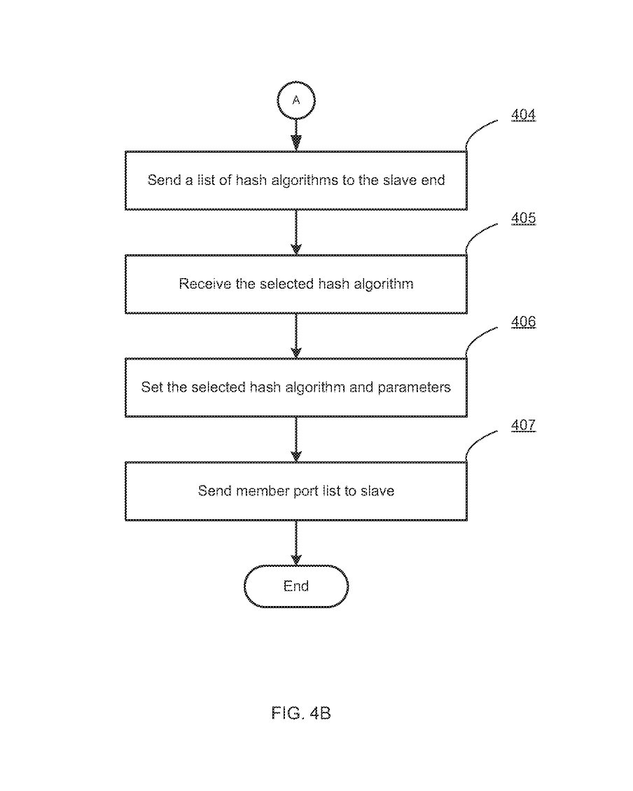

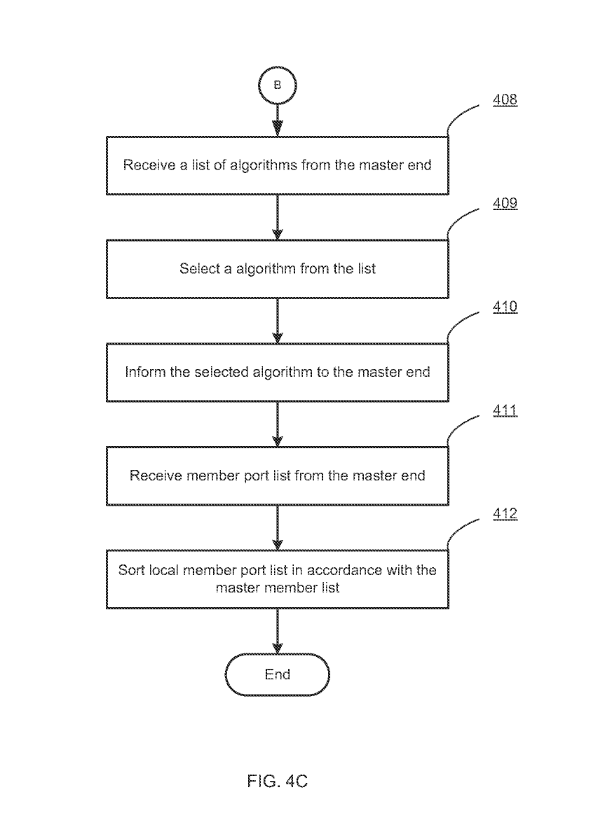

Negotiation unit 310 may also receive a member port list of the peer end from the peer end. After the member port list of the peer end is received, a mapping between member ports of the local end and the peer end is created and stored in member port mapping list 303 so that the orders in the member port mapping lists on both end of the LAG system are the same regardless of the order in which the physical ports are connected. Negotiation unit 310 may negotiate with the peer end regarding the algorithm (e.g., a link selection hash algorithm) and parameters for selecting the port for transmitting the bidirectional data flow to ensure member ports assigned by both ends when transmitting a bidirectional data flow are matched to the same member link even though both ends assign a member port for the transmission independently. Negotiation unit 310 may also negotiate with the peer end to decide which end become a master end that will control the procedures of exchanging member port lists and negotiation regarding the algorithm to select member ports between the ends in the LAG system. The operations of member port mapping list 303, negotiation unit 310 and frame distributor 307 will be described in further detail below with reference to FIGS. 4A-4C.

FIGS. 4A-4C are flow diagrams illustrating a method for negotiating between two ends of a link aggregation group system in determining the mechanism of assigning member links in accordance with an embodiment of the present invention. In the present example, two ends of a LAG system automatically determine which end will server as a master end that will control the procedures of negotiation of member port mapping and negotiation regarding the algorithm and parameters to be used for selecting member ports for data transmission in the LAG system.

At block 401, two ends of a LAG system exchange local parameters with each other. The local parameters may include, but are not limited to, a MAC address, an actor system ID or a partner system ID, and an actor system priority or a partner system priority of the local end. In one example, these parameters may be exchanged between the ends via a dedicated link aggregation control protocol (LACP) message. In another example, these parameters may be captured by both ends of the LAG system from LACP messages that are exchanged between the ends. In a further example, these local parameters may be exchanged using one or more messages of other protocols.

At block 402, the parameters of the remote end can be compared with the corresponding local parameters to determine which end becomes the master end of the LAG system. The MAC addresses, actor system IDs, partner system IDs, actor system priorities, partner system priorities and/or any combination thereof can be compared.

At block 403, the local end may determine if it is the master end of the LAG system based on the comparison result of block 402. For example, in one embodiment, the local end with a larger MAC address becomes the master end of the LAG system and the remote end become the slave end.

Blocks 401-403 merely represent one possible example of a procedure for automatically electing one end to be a master end of a LAG system. Those skilled in the art will appreciate that either end of the LAG system may be assigned as the master end by the administrator of the LAG system. It is also possible that the LAG system determines which end becomes the master end randomly. For example, when a local end that sends a LACP message first to a peer end, the local end that initiated the communication may be recognized as the master end. It is also possible that either end may send a message to its peer end requesting to be the master end. This end may become the master end if the peer end accepts the request.

Next, after one end has been selected as the master end of the LAG system, the master end may begin to transfer its member port list and negotiate with the slave about the algorithm and parameters that shall be used in connection with determining member ports for transferring data flow as explained immediately below with reference to FIG. 4B.

At block 404, a list of algorithms and corresponding parameters that are supported by the master end to determine member ports for data flow transmission is advertised to the slave end. The list of algorithms may include, for example, multiple hash algorithms by which hash values of data packets of data flows can be calculated by the master end when data flows are to be transferred to the slave end. The parameters that are advertised to the slave end may include fields and associated offsets of data packet that are to be used by the hash algorithms.

After the list of algorithms and corresponding parameters are received by the slave end, the slave end may select an algorithm and corresponding parameters from the list and send the selected algorithm and parameters back to the master end. The master end receives a selected algorithm and corresponding parameters from the slave end at block 405.

At block 406, the selected algorithm and parameters are set to be used in the future by the master end for determining a port of multiple member ports for transmitting data flows. In another example, the slave end may also advertise a list of algorithms and corresponding parameters that are supported by the slave end to the master end. Both ends may select the best algorithm and corresponding parameters that are supported by both ends from the lists of the master end and the slave end.

At block 407, a member port list of the master end is sent to the slave end. In one example, each port of member ports of both ends may be assigned a unique number by the LAG system. The member port list of the master end may be sorted based on the unique number assigned by the LAG system. In another example, the member port list of the master end may be sorted based on physical port number of the master end. The member port list of the master end may also be sorted based on the priority associated with the member ports and the unique number of member ports. One example of a sorted member port list of the master end is illustrated above by Table 1. To advertise the member port list to the slave end, the master end may send a message on each of its member ports indicating that port's unique number or physical port number. The message may be an LACP message and the unique number or physical port number of the current member port may be sent in the “actor port” field of the LACP message. The LACP message may also include the member port's relative/absolute priority value. For a LAG system shown in FIG. 2, the master end may send the following LACP messages:
At port 1, the master end sends an LACP message including “#1” in the “Actor port” field and “#1” in the “priority” field;
At port 3, the master end sends an LACP message including “#3” in the “Actor port” field and “#2” in the “priority” field;
At port 7, the master end sends an LACP message including “#7” in the “Actor port” field and “#1” in the “priority” field;
At port 8, the master end sends an LACP message including “#8” in the “Actor port” field and “#2” in the “priority” field.

It will be apparent to one skilled in the art that packet or messages other than LACP messages may be used by the master end to send its member port list to the slave end.

Now, the operations of a slave end of a LAG system are described below with reference to FIG. 4C.

At block 408, if a local end is determined to be the slave end of LAG system, the list of algorithms and parameters that are supported by the master end to determine a member port for data flow transmission is received by the slave end.

At block 409, the slave end may select the best algorithm and corresponding parameters that are supported by the slave end from the list received from the master end.

At block 410, the slave end may inform the master end of the selected algorithm and corresponding parameters.

In another example, the slave end may send a list of algorithms and corresponding parameters that are supported to the master end. In this example, both ends know all the algorithms that are supported by both ends. The master end and slave end may select the best algorithm and corresponding parameters that are supported by both ends.

At block 411, the slave end receives a member port list from the master end. The member port list of the master end may be sorted based on unique numbers assigned by the LAG system or by physical port number. In the example of FIG. 2, the slave end may receive the following LACP messages:
At port 1, the slave end receives an LACP message including “#8” in the “Actor port” field and “#2” in the “priority” field;
At port 2, the slave end receives an LACP message including “#1” in the “Actor port” field and “#1” in the “priority” field;
At port 4, slave end receives an LACP message including “#3” in the “Actor port” field and “#2” in the “priority” field;
At port 7, slave end receives an LACP message including “#7” in the “Actor port” field and “#1” in the “priority” field.

Then, the slave end may construct and save the member port list of the master end from these LACP messages locally. The member port list of master end may include information regarding unique numbers and the priorities of member ports that are directly connected to the member ports of the slave end.

At block 412, the slave end sorts its member port list according to the order of the member port list of the master end so that the connected member ports on both ends may be mapped to their counterparts on the other end. In the example, illustrated above in Table 1, the master end has sorted its member port list based on the priority and physical port number. On the slave end, following the lead of the master end, it has sorted its member port list in accordance with the order of the member port list of the master end. In this example, member port 6 of the slave end that received the LACP message including the highest priority and smallest port number of the master end is sorted to the top of the member port list of the slave end. Member port 4 of the slave end that received the LACP message including the lowest priority and largest port number of the master end is sorted to the bottom of the member port list of the slave end. Further, the mapping of the member port lists of both ends may be synchronized by way of LACP messages in real time when any of the member links is changed, for example, as a result of a broken/failed link or re-arrangement/re-assignment of ports. It will be apparent to one skilled in the art that the mapping table of member port lists may be maintained manually by the administrator of the LAG system without using LACP messages. It will also be apparent to one skilled in the art that the member port lists may be exchanged and/or synchronized using packets/messages other than LACP. Further, those skilled in the art will recognize that the slave end may also send its member port list to the master end so that mapping between the member port lists of both ends may be maintained locally at both ends.

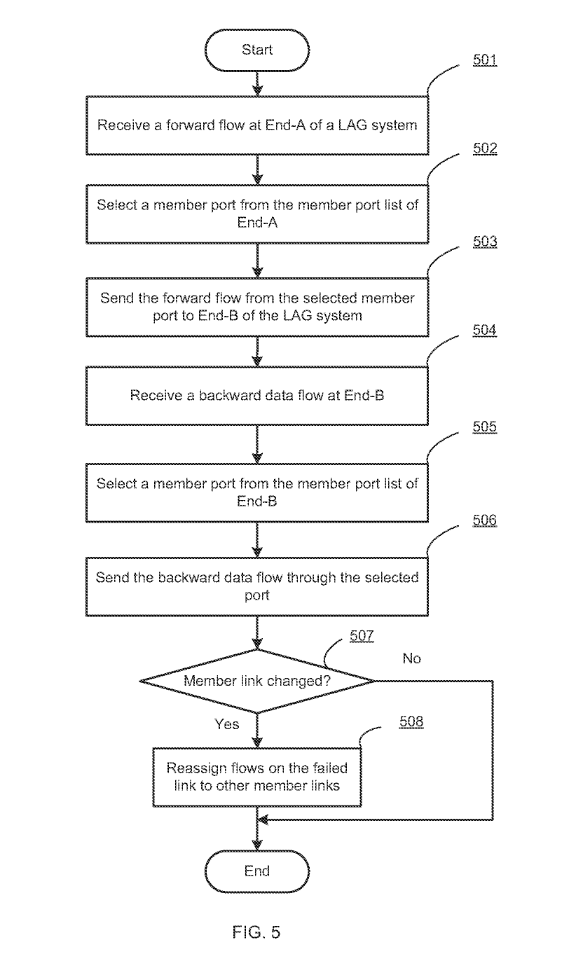

FIG. 5 is a flow diagram illustrating a method for transmitting a bidirectional data flow on the same member link of a LAG system in accordance with an embodiment of the present invention.

At block 501, an End-A of LAG system receives a forward data flow. The End-A may be either the master end or the slave end of the LAG system. The forward data flow is originated from a first network device, such as a client device that is connected to End-A, and is destined to a second network device, such as a server that is connected to an End-B of the LAG system. The forward data flow may include a request from the client device to the server.

At block 502, End-A selects a member port for transmitting the forward data flow to the remote end of LAG system. To assign the forward data flow to a member port, an algorithm and corresponding parameters that were agreed on by both ends during the configuration stage are used. For example, End-A may use a hash algorithm to calculate a hash value of some header fields of each packet of the forward data flow. For example, a remainder, n, of the hash value to the number of member ports of End-A may be calculated. Then, the n-th member port in a member port list of End-A is selected for transmitting the packet of the forward data flow. That is, the forward data flow is assigned to the selected member port.

At block 503, the forward data flow is sent to End-B of LAG system from the assigned member port.

After the forward data flow is received from End-A, End-B routes the forward data flow to its destination (e.g., the second network device that is connected to End-B of the LAG system). Then, the second network device, such as the server, responds to the request of the forward data flow. The response is a backward data flow in the opposite direction to the forward data flow. The backward data flow and forward data flow of the bi-directional data flow have opposite source IP addresses/port numbers and destination IP addresses/port numbers.

At block 504, End-B of the LAG system receives the backward data flow from the second network device.

At block 505, End-B of the LAG system selects a member port for transmitting the backward data flow to End-A of LAG system. To assign the backward data flow to a member port, the algorithm and corresponding parameters that were previously agreed on during the configuration stage are used. For example, End-B may use the same hash algorithm as that of End-A to calculate a hash value of the same header fields of each packet of the backward data flow. In one embodiment, a remainder, n, of the hash value to the number of member ports of End-B is calculated. Then, the n-th member port in a member port list of End-B is selected for transmitting the packet of the backward data flow. Because the hash algorithm and corresponding parameters used on End-B of the LAG system are the same as that of End-A of the LAG system, the hash value and the remainder, n, are the same for the forward data flow and the backward data flow. Further, the member port lists on both ends are sorted in the same order such that member ports that are directly connected by a member link are sorted at the same position on the member port lists on the both ends. Therefore, when End-B assigns the n-th member port of its member port list to the backward data flow that is to be sent to End-A, the n-th member port is the member port on which the corresponding forward data flow is received by End-B from End-A to ensure that the forward data flow and the backward data flow of the bidirectional data flow are transmitted on the same member link of the LAG system.

At block 506, the backward data flow is sent on the member port of End-B as selected above so as to ensure that the forward data flow and the corresponding backward data flow are transmitted on the same member link of the LAG system.

At block 507, the LAG system detects if a member link has changed, such as broken or re-connected to another port. For example, when a cable of a LAG system is broken or a port of a switch of the LAG system has failed for some reason, the number of member links of the LAG system is reduced. In another example, when a cable of a LAG system is un-plugged from one port and plugged to another port of a switch, the member link of the LAG system is re-arranged.

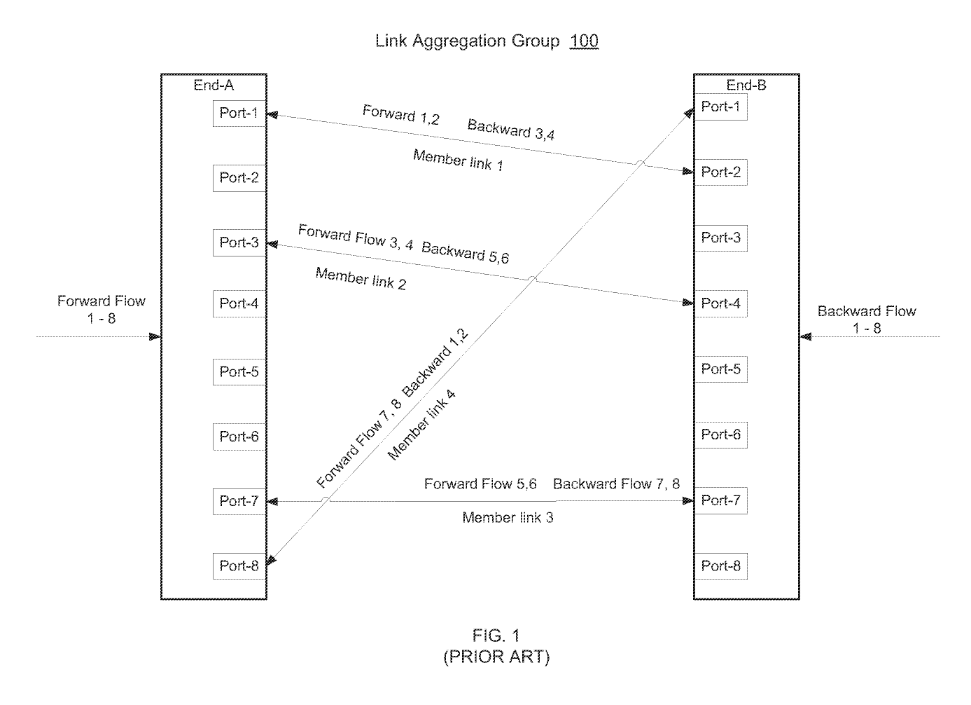

At block 508, if a member link is broken, for example, the member port lists on both ends of the LAG system may be updated and synchronized. Then, data flows on the failed member link are re-assigned to member ports based on the updated member port lists. In the example of FIG. 2, when member link 4 fails, the bidirectional data flow 7,8 is re-assigned because only forward data flow 7,8 and backward data flow 7,8 were transmitted on member link 4. In the example of FIG. 1, when member link 4 of a LAG system, performing asymmetric end-to-end member link selection, fails, data flows 1,2 and 7,8 must be re-assigned as forward data flow 7,8 and backward data flow 1,2 were transmitted on member link 4. In accordance with embodiments of the present invention, the number of data flows effected by a member link failure and needing to be re-assigned are fewer than the number effected in the context of prior art LAG systems.

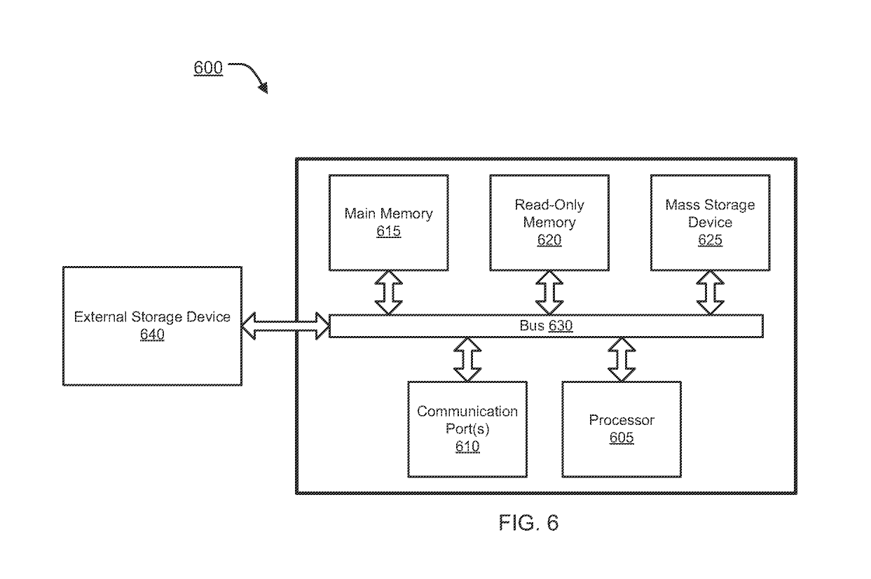

FIG. 6 is an example of a computer system 600 with which embodiments of the present disclosure may be utilized. Computer system 600 may represent or form a part of a network appliance, a server, a client workstation or other network devices that may serve as an end point of a LAG system.

Embodiments of the present disclosure include various steps, which have been described in detail above. A variety of these steps may be performed by hardware components or may be tangibly embodied on a computer-readable storage medium in the form of machine-executable instructions, which may be used to cause a general-purpose or special-purpose processor programmed with instructions to perform these steps. Alternatively, the steps may be performed by a combination of hardware, software, and/or firmware.

As shown, computer system 600 includes a bus 630, a processor 605, communication port 610, a main memory 615, a removable storage media 640, a read only memory 620 and a mass storage 625. A person skilled in the art will appreciate that computer system 600 may include more than one processor and communication ports.

Examples of processor 605 include, but are not limited to, an Intel® Itanium® or Itanium 2 processor(s), or AMD® Opteron® or Athlon MP® processor(s), Motorola® lines of processors, FortiSOC™ system on a chip processors or other future processors. Processor 605 may include various modules associated with embodiments of the present invention.

Communication port 610 can be any of an RS-232 port for use with a modem based dialup connection, a 10/100 Ethernet port, a Gigabit or 10 Gigabit port using copper or fiber, a serial port, a parallel port, or other existing or future ports. Communication port 610 may be chosen depending on a network, such a Local Area Network (LAN), Wide Area Network (WAN), or any network to which computer system 600 connects.

Memory 615 can be Random Access Memory (RAM), or any other dynamic storage device commonly known in the art. Read only memory 620 can be any static storage device(s) such as, but not limited to, a Programmable Read Only Memory (PROM) chips for storing static information such as start-up or BIOS instructions for processor 605.

Mass storage 625 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), such as those available from Seagate (e.g., the Seagate Barracuda 7200 family) or Hitachi (e.g., the Hitachi Deskstar 7K1000), one or more optical discs, Redundant Array of Independent Disks (RAID) storage, such as an array of disks (e.g., SATA arrays), available from various vendors including Dot Hill Systems Corp., LaCie, Nexsan Technologies, Inc. and Enhance Technology, Inc.

Bus 630 communicatively couples processor(s) 605 with the other memory, storage and communication blocks. Bus 630 can be, such as a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor 605 to system memory.

Optionally, operator and administrative interfaces, such as a display, keyboard, and a cursor control device, may also be coupled to bus 630 to support direct operator interaction with computer system 600. Other operator and administrative interfaces can be provided through network connections connected through communication port 610.

Removable storage media 640 can be any kind of external hard-drives, floppy drives, IOMEGA® Zip Drives, Compact Disc—Read Only Memory (CD-ROM), Compact Disc—Re-Writable (CD-RW), Digital Video Disk—Read Only Memory (DVD-ROM).

Components described above are meant only to exemplify various possibilities. In no way should the aforementioned exemplary computer system limit the scope of the present disclosure.

While embodiments of the invention have been illustrated and described, it will be clear that the invention is not limited to these embodiments only. Numerous modifications, changes, variations, substitutions, and equivalents will be apparent to those skilled in the art, without departing from the spirit and scope of the invention, as described in the claims.

What is claimed is:

1. A method comprising:
receiving a forward data flow of a bidirectional data flow from a first end of a link aggregation group (LAG) system by a second end of the LAG system, wherein the forward data flow of the bidirectional data flow is from a first network device that is connected to the first end of the LAG system to a second network device that is connected to the second end of the LAG system;
transmitting, by the second end of the LAG system, the forward data flow to the second network device;
receiving, by the second end of LAG system, a backward data flow of the bidirectional data flow that is from the second network device to the first network device;
assigning, by the second end of the LAG system, the backward data flow to a member link on which the forward data flow was received by the second end of the LAG system; and
transmitting, by the second end of the LAG, the backward data flow to the first end of the LAG system through the assigned member link.

2. The method of claim 1, wherein said assigning, by the second end of the LAG system, the backward data flow to a member link on which the forward data flow is received by the second end of the LAG system further comprises:
establishing a mapping between member ports of the first end and the second end of the LAG system; and
selecting, by the second end of the LAG system, a member port from the mapping for transmitting the backward data flow based on information regarding the backward data flow, wherein the member port selected from the mapping corresponds to a port of the second end of the LAG system on which the forward data flow was received from the first end of the LAG system.

3. The method of claim 2, further comprising:
establishing, by a master end of the LAG system, a first list of member ports of the master end, wherein the master end is either the first end or the second end of the LAG system;
establishing, by a slave end of the LAG system, a second list of member ports of the slave end, wherein the slave end is the first end when the master end is the second end and the slave end is the second end when the master end is the first end;
receiving, by the slave end of the LAG system, the first list of member ports of the master end; and
sorting, by the slave end of the LAG system, member ports of the second list in accordance with an ordering used for the member ports of the first list.

4. The method of claim 3, wherein the master end is designated by a user of the LAG system.

5. The method of claim 3, further comprising electing the master end as a result of a negotiation between the first end and the second end.

6. The method of claim 5, wherein the master end is elected based on information comprising one or more of:
media access control (MAC) addresses of the first end and the second end;
actor system IDs and partner system IDs of the first end and the second end; and
actor system priorities and partner system priorities of the first end and the second end.

7. The method of claim 6, wherein the information is transmitted in a link aggregation control protocol (LACP) message between the first end and the second end.

8. The method of claim 6, wherein the information is transmitted in a message exchanged between the first end and the second end.

9. The method of claim 3, further comprising negotiating between the master end and the slave end to determine an algorithm and parameters for assigning flows to their respective member ports.

10. The method of claim 9, wherein said negotiating between the master end and the slave end comprises:
advertising, by the master end and the slave end, supported algorithms and corresponding fields and offsets of data packets used by the supported algorithms to the other end; and
determining, by the master end and the slave end a common algorithm of the supported algorithms and the corresponding fields and the offset to be used for assigning the flows.

11. The method of claim 10, wherein the common algorithm comprises a hash algorithm.

12. The method of claim 3, further comprising:
assigning a unique number to each of the member ports of the first list of member ports of the master end and to each of the member ports of the second list of member ports of the slave end; and
sorting the first list of member ports of the master end based on the assigned unique numbers.

13. The method of claim 3, further comprising:
sending, by the master end, the first list of member ports to the slave end in an LACP message; and
sending, by the slave end, the second list of member ports to the master end in an LACP message.

14. The method of claim 3, further comprising determining, by the slave end, the first list of member ports of the master end based on an actor port field of an LACP message sent from the master end.

15. The method of claim 3, further comprising determining, by the slave end, the first list of member ports of the master end based on an actor port field and a port priority field of an LACP message sent from the master end.

16. The method of claim 1, further comprising when the member link fails, reassigning, by the first end and the second end, the forward data flow and the backward data flow to another member link of the LAG system.

17. A ling aggregation group (LAG) system comprising:
a first end network device including a first plurality of member ports;
a second end network device including a second plurality of member ports connected to corresponding member ports of the first plurality of member ports by cables to establish multiple member links of the LAG system; and
wherein the first end network device and the second end network device are operable within a network to perform a method comprising:
receiving, by the second end network device, a forward data flow of a bidirectional data flow from the first end network device, wherein the forward data flow of the bidirectional data flow is originated by a first node of the network that is connected to the first end network device and directed to a second node of the network that is connected to the second end of the LAG system;
transmitting, by the second end network device, the forward data flow to the second node;
receiving, by the second end network device, a backward data flow of the bidirectional data flow that is originated by the second node and directed to the first node;
assigning, by the second end network device, the backward data flow to a member link of the multiple member links on which the forward data flow was received by the second end network device; and
transmitting, by the second end network device, the backward data flow to the first end network device through the assigned member link.

18. The LAG system of claim 17, wherein said assigning, by the second end network device, the backward data flow to a member link further comprises:
establishing a mapping between the first plurality of member ports and the second plurality of member ports; and
selecting, by the second end network device, a member port from the mapping for transmitting the backward data flow based on information regarding the backward data flow, wherein the selected member port corresponds to a port of the second plurality of member ports on which the forward data flow was received by the second end network device from the first end network device.

19. The LAG system of claim 18, wherein the method further comprises:
establishing, by a master end of the LAG system, a first list of member ports, wherein the master end is either the first end network device or the second end network device;
establishing, by a slave end, a second list of member ports, wherein the slave end is the first end network device when the master end is the second end network device and the slave end is the second end network device when the master end is the first end network device;
receiving, by the slave end, the first list of member ports; and
sorting, by the slave end, the second list of member ports in accordance with an ordering used for the first list of member ports.

20. The LAG system of claim 19, wherein the master end is designated by a user of the LAG system.

21. The LAG system of claim 19, wherein the method further comprises electing the master end as a result of a negotiation between the first end network device and the second end network device.

22. The LAG system of claim 21, wherein the master end is elected based on information comprising one or more of:
media access control (MAC) addresses of the first end network device and the second end network device;
actor system IDs and partner system IDs of the first end network device and the second end network device; and
actor system priorities and partner system priorities of the first end network device and the second end network device.

23. The LAG system of claim 22, wherein the information is transmitted in a link aggregation control protocol (LACP) message between the first end network device and the second end network device.

24. The LAG system of claim 19, wherein the method further comprises determining an algorithm and parameters for assigning flows to their respective first or second plurality of member ports by negotiating between the master end and the slave end to determine

25. The LAG system of claim 24, wherein said determining an algorithm comprises:
advertising, by the master end and the slave end, supported algorithms and corresponding fields and offsets of data packets used by the supported algorithms to the other end; and
determining, by the master end and the slave end a common algorithm of the supported algorithms and the corresponding fields and the offset to be used for assigning the flows.

26. The LAG system of claim 17, wherein the method further comprises when the member link fails, reassigning, by the first end network device and the second end network device, the forward data flow and the backward data flow to another member link of the multiple member links.
